(19) United States
(12) Patent Application Publication
(10) Pub. No.: US 2026/0283176 A1
(43) Pub. Date: Sep. 24, 2026

(54) FOODSTUFF

(71) Applicant: Marlow Foods Limited, Stokesley (GB)

(72) Inventors: Albertus Antonius Gerardus HAFKAMP, Stokesley (GB); Willem Cornelis MEIJER, Stokesley (GB); Anna Jayne TAYLOR, Stokesley (GB); Linda Christina PRAVINATA, Stokesley (GB)

(21) Appl. No.: 19/469,457

(22) PCT Filed: Feb. 29, 2024
(86) PCT No.: PCT/GB2024/050544

§ 371 Date: Sep. 26, 2025

(30) Foreign Application Priority Data
Mar. 27, 2023 (GB) 2304455.5

(51) Int. Cl. A23C 11/10; A23L 31/00

(52) U.S. Cl. CPC A23C 11/10; A23L 31/00

(57) ABSTRACT

A foodstuff, for example a vegan yoghurt, includes a filamentous fungus, for example Fusarium venenatum; and a plant-based milk, for example coconut milk or an oat milk. The foodstuff may have excellent taste without a beanie or bitter taste. The foodstuff may be a plain (or natural) vegan yoghurt including low or no added flavourings such as fruit-based flavourings. Also, the foodstuff can deliver relatively high levels of protein having a high PDCAAS score and has excellent colour, rheology and mouth-feel.

This invention relates to a foodstuff and particularly, although not exclusively, relates to a yoghurt-like foodstuff which includes no animal products and is therefore suitable for vegans. Such a foodstuff may be referred to herein as aforesaid or as a “vegan yoghurt”, a vegan yoghurt-like foodstuff (or similar term). Especially preferred embodiments relate to a vegan yoghurt-like foodstuff which includes no additional flavourings and is similar and/or mimics plain (or “natural”) dairy yoghurt.

Soy-based, oat-based and other plant-based vegan yoghurt-like foodstuffs are well known and are sold under a range of brands including ALPRO™ and OATLY™. However, disadvantageously, some such yoghurt-like foodstuffs may include undesirable off-notes, for example a beanie, oatie or bitter taste. This is because the plant-based ingredients tend to be relatively heavily processed, for example involving heating and solvent extraction steps, to produce a protein isolate or concentrate. Disadvantageously, steps taken to optimise the level of desirable protein in the isolate/concentrate also tend to concentrate undesirable off-notes in addition. Consequently, some plant-based yoghurt-like foodstuffs include relatively high levels of sugar to mask the undesirable taste. However, this can make the foodstuff taste too sweet. Alternatively, the taste may be masked by addition of other flavourings, such as fruit preparations or fruit-based flavourings.

It follows that it is very challenging, in general, to produce an acceptable yoghurt-like foodstuff, based on ingredients of non-animal origin, which is similar to a plain or natural yoghurt—that is, a yoghurt-like foodstuff with no additional flavourings such as fruit preparations or the like. It is also challenging to produce a yoghurt-like foodstuff which is high in protein.

In addition to a yoghurt-like foodstuff being high in protein (and preferably including a protein source which has a high Protein Digestibility Corrected Amino Acid Score (PDCAAS), for example at or approaching a score of 1), and having excellent natural taste, without the need to include additional flavourings to mask undesirable off-notes, the foodstuff must have acceptable colour, rheology and/or mouthfeel which mimics that of dairy yoghurt. Achieving all the aforesaid in a practical, commercially relevant manner, is a significant challenge.

It is an object of preferred embodiments of the present invention to address the above-mentioned problems.

It is an object of preferred embodiments of the present invention, to provide a vegan yoghurt-like foodstuff which includes no additional flavourings and is similar and/or mimics plain (or “natural”) dairy yoghurt.

According to a first aspect of the invention, there is provided a foodstuff, for example a vegan yoghurt, the foodstuff comprising:
a filamentous fungus; and
a plant-based milk.

Advantageously, foodstuffs described herein have high consumer acceptability. They have excellent taste without a beanie or bitter taste often associated with vegan yoghurts/plant-based ingredients such as soy. Whilst filamentous fungus per se may exhibit off-notes, such off-notes are not apparent in the foodstuff. This is believed to be a result of the combination of the filamentous fungus and the milk and/or fermentation of ingredients used in making the foodstuff. Thus, plain (or natural) vegan yoghurt can be produced, thereby avoiding the need to add flavourings such as fruit-based flavourings to mask any undesirable taste. In addition, the foodstuffs can deliver relatively high (eg 5%) levels of protein having a high PDCAAS score and have excellent colour, rheology and mouth-feel. As a result, the foodstuffs closely mimic dairy yoghurts and may therefore be a vegan yoghurt substitute.

Said milk is preferably lactose-free.

Said milk may include 0.1 to 15.0 wt %, preferably 0.1 to 10.0 wt %, more preferably 0.5 to 8.0 wt %. of carbohydrates.

Said milk may include 0.10 to 10.0 wt %, preferably 0.10 to 5.0 wt %, more preferably 0.15 to 3.0 wt %, especially 0.20 to 2.0 wt % of protein.

Said milk may include 1.0 to 20.0 wt %, preferably 2.0 to 18.0 wt % fat.

Said milk may be derived from coconuts, almonds, cashews, hazelnuts, hemp, spelt, oat, rice or soy, pea or mung beans.

Said milk is preferably coconut milk and/or oat milk.

Said foodstuff may include 1 to 20 wt %, preferably 2 to 15 wt %, more preferably 4 to 14 wt % of said milk. The amount of said milk suitably refers to the amount used in preparing the foodstuff and is irrespective of whether the milk is modified or reacted during preparation, for example, fermentation to produce the foodstuff.

Said foodstuff may include one or a plurality of plant-based milks. The sum of the wt % of all plant-based milks in the foodstuff may be 1 to 20 wt %, preferably 2 to 15 wt %, more preferably 4 to 14 wt %, of said milk.

Unless otherwise stated herein, the amount of filamentous fungus is on a dry mass basis. The term “dry mass basis” (or similar term) refers to the weight of a particular component based on its dry mass—that is, excluding any water or other fluid which may be associated with the component. For example, mycoprotein paste referred to herein may be produced so that it includes about 25 wt % solids (the balance being water) made up of non-viable RNA reduced fungal hyphae. The paste may be said to include 25 wt % of fungal hyphae on a dry mass basis and 75 wt % water. In this example, the dry mass basis may be determined by heating the mycoprotein paste to remove the water and calculating the water wt % by comparing the weight of the paste before and after water removal.

Said filamentous fungus may have a Protein Digestibility Corrected Amino Acid Score (PDCAAS) of at least 0.95, preferably at least 0.99.

Said filamentous fungus may include at least 35 wt %, preferably at least 40 wt %, protein on a dry mass basis. Said filamentous fungus may include less than 65 wt %, preferably less than 60 wt %, protein on a dry mass basis.

Said filamentous fungus may include at least 10 wt %, preferably at least 15 wt %, dietary fibre on a dry mass basis. Said filamentous fungus may include less than 40 wt %, preferably less than 35 wt %, dietary fibre on a dry mass basis.

Said filamentous fungus may include at least 5 wt %, preferably at least 10 wt %, fat on a dry mass basis. Said filamentous fungus may include less than 20 wt %, preferably less than 15 wt %, fat on a dry mass basis.

Said filamentous fungus may comprise filaments. Said filaments may have lengths of less than 100 μm, preferably less than 50 μm. Said filaments may have a length greater than 5 μm. Preferably, fewer than 5 wt %, preferably substantially no, filaments of said filamentous fungus have lengths of greater than 200 μm; and preferably fewer than 5 wt %, preferably substantially no filaments have lengths of greater than 100 μm. Preferably, values for the number average of the lengths of said filaments are also as stated above. Thus, the number average of the lengths of said filaments may be in the range 5 μm to 100 μm, preferably in the range 10 μm to 60 μm.

Said filamentous fungus may comprise filaments having diameters of less than 20 μm, preferably less than 10 μm, more preferably 5 μm or less. Said filaments may have diameters greater than 1 μm, preferably greater than 2 μm. Preferably, values for the number average of said diameters of said filaments are also as stated above. Thus, the number average of said diameters of said filaments are preferably in the range 1 μm to 20 μm.

Preferably, said filamentous fungus is defined by filaments of a filamentous fungus. Said filamentous fungus preferably comprises fungal mycelia and suitably at least 80 wt %, preferably at least 90 wt %, more preferably at least 95 wt % and, especially, at least 99 wt % of said filamentous fungus comprise fungal mycelia. Some filamentous fungi may include both fungal mycelia and fruiting bodies. Said filamentous fungus preferably comprise a filamentous fungus of a type which does not significant produce fruiting bodies.

Said filamentous fungus preferably comprises fungus selected from fungi imperfecti.

Preferably, said filamentous fungus comprises, and preferably consists essentially of, cells of Fusarium species, especially of Fusarium venenatum A3/5 (formerly classified as Fusarium graminearum) (IMI 145425; ATCC PTA-2684 deposited with the American Type Culture Collection, 10801 University Boulevard, Manassas, VA.).

Preferably, said filamentous fungus is non-viable. Preferably, said filamentous fungus has been treated to lower the level of RNA which it contains. Thus, the level of RNA in said filamentous fungus is preferably less than the level in an identical fungus when in a viable state. The level of RNA in the filamentous fungus is preferably less than 2 wt % on a dry mass basis.

Said filamentous fungus is suitably derived from a biomass (eg a mycoprotein paste as described herein) comprising said filamentous fungus, wherein said biomass preferably has an L* of at least 70.0.

L* of said biomass may be assessed as described hereinafter.

Said biomass may have an L* of at least 75.0, suitably at least 80.0, preferably at least 82.0, more preferably at least 84.0, especially at least 85.0.

The L* of said biomass may be less than 95.0 or less than 91.0.

The biomass may have an a*, assessed as described hereinafter, of less than 2.9, suitably less than 2.5, preferably less than 2.0, more preferably less than 1.5. The a* may be at least-1.0.

The biomass may have an b*, assessed as described hereinafter, of less than 14.0, suitably less than 10.0, preferably less than 9.0. The b* may be at least 0.5.

Said biomass may have a pH of at least 2.0, preferably at least 3.0, more preferably at least 3.5. The biomass may have a pH of less than 6.0, suitably less than 5.0, preferably less than 4.5, more preferably less than 4.1.

Said biomass may have:
L* in the range 75.0 to 95.0, preferably in the range 82.0 to 91.0; and/or
a* in the range-1.0 to 2.9, preferably in the range 0 to 2.0; and/or
b* in the range 0.5 to 14.0, preferably in the range 0.5 to 10.0; and/or
a pH in the range 2.0 to 6.0, preferably in the range 3.5 to 5.0.

Said pH may be measured as described herein, for example using a needle-type pH electrode with built-in temperature compensation.

Said foodstuff suitably includes at least 1.0 wt %, preferably at least 2.0 wt %, more preferably at least 4.0 wt %, especially at least 5.0 wt %, of said filamentous fungus on a dry mass basis. Said foodstuff may include less than 15.0 wt %, suitably less than 12.0 wt %, preferably less than 11.0 wt %, more preferably less than 10.0 wt %, of said filamentous fungus on a dry mass basis.

Said foodstuff suitably includes 1.0 to 15.0 wt %, preferably 2.0 to 12.0 wt %, more preferably 4.0 to 11.0 wt %, especially 5.0 to 10.0 wt %, of said filamentous fungus on a dry mass basis.

Preferably, in said foodstuff, the sum of the wt % of said filamentous fungus on a dry mass basis and said milk is at least 10 wt %, preferably at least 15 wt %. Said sum may be less than 30 wt %, preferably less than 25 wt %, especially less than 20 wt %.

A reference herein to the weight of water in said composition suitably refers to the total water content in the composition irrespective of its origin.

Said foodstuff may include at least 50 wt %, preferably at least 60 wt %, more preferably at least 70 wt % of water. The amount of water in said foodstuff may be less than 85 wt %, preferably less than 80 wt %.

Preferably, in said foodstuff, the sum of the wt % of said filamentous fungus on a dry mass basis, said milk and water is at least 80 wt %, preferably at least 85 wt %, more preferably at least 90 wt %. Said sum may be less than 100 wt %, preferably less than 96 wt %, especially less than 94 wt %.

In said foodstuff, suitably, a ratio defined as the weight of said filamentous fungus material on a dry mass basis divided by the weight of water is greater than 0.05, preferably is greater than 0.06. The ratio may be less than 0.20, preferably less than 0.15, more preferably less than 0.13.

Said foodstuff may include:
1 to 15 wt %, preferably 5 to 10 wt %, of said filamentous fungus on a dry mass basis; and
1 to 20 wt %, preferably 4 to 14 wt %, of said milk.

The balance may include other ingredients including water. Said foodstuff may include 50 to 80 wt %, preferably 70 to 80 wt %, of water.

The sum of the wt % of plant-based milks in the foodstuff may be in the range 1 to 20 wt %, preferably 4 to 14 wt %; and the wt % of said filamentous fungus on a dry mass basis in said foodstuff may be in the range 1 to 15 wt %, preferably 5 to 10 wt %, of said milk. The balance may include other ingredients including water. Said foodstuff may include 50 to 80 wt %, preferably 70 to 80 wt %, of water.

Said foodstuff suitably includes one or more stabilisers. The sum of the wt % of stabilisers in said foodstuff may be at least 0.1 wt %, preferably at least 0.4 wt %. Said sum may be less than 3.0 wt %, preferably less than 2.5 wt %. A said stabiliser may include one or more selected from pectin, guar gum, xanthan gum, carrageenan gum and a starch which may be a natural starch or may be selected from modified starches. Preferred stabilisers may include pectin and/or a starch, for example tapioca starch. A combination comprising pectin and tapioca starch may be used to produce a smoother vegan yoghurt. To enhance the effect of the stabilisers and/or enhance gelation, the foodstuff may include minerals, for example cations (eg of calcium, iron, magnesium, cobalt or manganese) which can bind to the stabilisers.

Said foodstuff suitably includes a residue of a starter culture, for example a bacterial culture. Said foodstuff suitably includes a residue of a Lactobacillus and/or of a Streptococcus. Said foodstuff may include a residue of a starter culture selected from Lactobacillus delbrueckii. Lactobacillus acidophilus, Lactobacillus paracasei, Lactobacillus plantarum, Lactobacillus helveticus, Pediococcus acidilacti, Bifidobacterium sp. and Streptococcus thermophilus. Preferably, said foodstuff includes a residue of a Lactobacillus, for example Lactobacillus delbrueckii and/or of a Streptococcus, for example Streptococcus thermophilus.

Advantageously, the foodstuff need not include any added flavourant, such as a fruit flavourant, to mask any off-notes, in contrast to many prior art vegan yoghurts. Thus, said foodstuff preferably includes less than 10 wt %, less than 5 wt %, less than 3 wt %, less than 1 wt %, less than 0.5 wt %, or less than 0.1 wt %, of added flavourant, such as a fruit or fruit flavourant, Preferably, said foodstuff includes 0 wt % of added flavourant, such as a fruit or fruit flavourant. The foodstuff may mimic plain (or “natural”) dairy yoghurt. The foodstuff is suitably a plain (or “natural”) foodstuff, for example vegan yoghurt.

Said foodstuff suitably has a protein content of at least 5 g/100 g, preferably at least 8 g/100 g, more preferably at least 10 g/100 g of protein. The protein content may be less than 25 g/100 g or less than 25 g/100 g. Unless otherwise stated protein levels described herein may be assessed by the Dumas method.

Said foodstuff is suitably lactose-free.

Said foodstuff preferably includes 0 wt % of ingredients of animal origin. Said foodstuff is preferably suitable for vegans. Said foodstuff is preferably a yoghurt-substitute which includes no animal products.

Said foodstuff may be in the form of a non-gaseous fluid.

Unless otherwise stated, viscosity described herein may be measured with a Brookfield RV viscosity meter with spindle 5 which is rotated @ 50 rpm in the foodstuff at a temperature of 20° C. for 1 minute prior to measurement of viscosity in mPa.

Said foodstuff may have a viscosity of at least 3000 mPa, preferably at least 3500 mPa. The viscosity may be less than 15000 mPa or less than 13000 mPa. In one embodiment, the foodstuff may be a drinking vegan yoghurt having a viscosity in the range 3000 mPa to 4500 mPa. In another embodiment, the foodstuff may be a spoonable vegan yoghurt having a viscosity in the range 4500 to 10000 mPa or in the range 5000 to 9000 mPa. In another embodiment, the foodstuff may be a Greek-style vegan yoghurt having a viscosity in the range 8000 to 14000 mPa or in the range 10000 to 13000 mPa.

Said foodstuff may advantageously exhibit less than 5% syneresis, or less than 3% or less than 1%. It preferably exhibits less than 0.5%, less than 0.1% or 0% syneresis. Syneresis may be assessed as described hereinafter.

Said foodstuff is preferably provided in a package, for example a receptacle. The internal volume of the package may be in the range 50 ml to 1000 ml, for example 75 ml to 500 ml. The package may contain 100 to 1000 g of said foodstuff, for example 75 to 250 g of said foodstuff.

According to a second aspect of the invention, there is provided a process of making a foodstuff, the process comprising mixing a filamentous fungus and a plant-based milk.

Said foodstuff may have any feature of the foodstuff of the first aspect. Said filamentous fungus may have any feature of the filamentous fungus of the first aspect. Said plant-based milk may have any feature of the plant-based milk of the first aspect.

Advantageously, a biomass may be selected comprising said filamentous fungus which biomass is relatively white and therefore may be used to produce a foodstuff which is relatively white. Said biomass may have L* in the range 75.0 to 95.0, preferably in the range 82.0 to 91.0. Said biomass may have:
a* in the range-1.0 to 2.9, preferably in the range 0 to 2.0; and/or
b* in the range 0.5 to 14.0, preferably in the range 0.5 to 10.0; and/or
a pH in the range 2.0 to 6.0, preferably in the range 3.5 to 5.0.

In a step (i), a biomass comprising said filamentous fungus is suitably selected. Said biomass may be in the form of a paste. Said biomass may include 20-30 wt % of filamentous fungus on a dry mass basis and 70-80 wt % of water.

As an alternative to the biomass being in the form of a paste, it may comprise a non-gaseous fluid. Advantageously, such a fluid can readily flow and be conveyed and contacted with other ingredients, for example said milk.

Said process may include contacting the filamentous fungus with said plant-based milk, suitably with mixing. This preferably breaks down filaments of the filamentous fungus and/or breaks down oil droplets in the plant-based milk which may contribute to the smoothness and mouth-feel of the foodstuff produced.

Said process may comprise inoculating a mixture of the filamentous fungus and said milk, for example with a bacterial culture, for example arranged to catalyse a fermentation reaction. The process preferably comprises a fermentation process, for example comprising said filamentous fungus and said milk and optional carbohydrate. The fermentation is suitably undertaken to produce a mixture having a pH of less than 4.50. After said fermentation, the mixture may be introduced into a package as described in the first aspect.

Any feature of any aspect of any invention described herein may be combined with any feature of any other invention described herein mutatis mutandis.

Specific embodiments of the invention will now be described, by way of example.

The following materials are referred to herein:

Mycoprotein paste-Mycoprotein paste-refers to a visco-elastic material comprising a mass of edible filamentous fungus derived from Fusarium venenatum A3/5 (formerly classified as Fusarium graminearum Schwabe) (IMI 145425; ATCC PTA-2684 deposited with the American type Culture Collection, 12301 Parklawn Drive, Rockville Md. 20852) and treated to reduce its RNA content to less than 2% by weight by heat treatment. Further details on the material are provided in WO96/21362 and WO95/23843. The material may be obtained from Marlow Foods Limited of Stokesley, U.K. It comprises about 23-25 wt % solids (the balance being water) made up of non-viable RNA reduced fungal hyphae of approximately 400-750 μm length, 3-5 μm in diameter and a branching frequency of 2-3 tips per hyphal length.

Frozen mycoprotein paste-Mycoprotein paste frozen in blocks and held in a freezer at −18° C. or lower until required. The material specification was as follows:
26-32 wt % solids;
3.1 g/100 g fat
1 g/100 g carbohydrate
<0.1 g/100 g sugars
7.5 g/100 g dietary fibre
14 g/100 g protein (equates to about 53 wt % protein on a dry mass basis) water to balance.

Coconut milk—Typically containing 17% fat; 0.8% carbohydrates; 1% protein; 0.06% salt and guar gum (E412).

Oatmilk, Oatly full—Typically containing 2.8% fat; 7.1% carbohydrates; 0.8% fibre; 1.1% protein; 0.10% salt).

Trilesse AYS 0688 DF—A powdered stabiliser containing starch (from maize origin) and pectin from Cargill.

Starter culture—refers to CHR Hansen Vega Classic starter culture comprising Lb. delbrueckii spp bulgaricus and Streptococcus thermophilus

The following tests and assessments are referred to herein.

### Test 1—Measurement of Viscosity

Viscosity of foodstuffs described in the Examples was measured with a Brookfield RV viscosity meter with spindle 5, rotated @ 50 rpm in the foodstuff at a temperature of 20° C. for 1 minute prior to measurement of viscosity in mPa.

### Test 2—Assessment of Syneresis

Five test tubes of 15 ml are filled with 10 grams of foodstuff to be assessed. The test tubes are placed in a cold chamber at 7° C. After 7, 14, 21, 28 and 40 days a test tube is taken and the clear liquid on top of the yoghurt is removed and weighed. The percentage of syneresis is calculated from the following equation:

$$Syneresis ( \% ) = Total weight of separated liquid ( g ) / Total weight of the foodstuff sample ( g ) \times 100.$$

### Example 1—General Procedure for Preparing Yoghurt-Like Foodstuffs

Yoghurt-like foodstuffs were prepared in batches of 10 kg as described below.

Frozen Mycoprotein paste is defrosted in a 4° C. room. The defrosted blocks are mixed with other ingredients (eg milk(s), sucrose, glucose and water) in a Electrolux Bermixer blender. The resulting slurry is then mixed using an IKA T25 Ultraturrax with suitable disperser unit till smaller pieces are produced which are able to be homogenized by a Twin Panda Homogeniser supplied by GEA.

Trilesse is weighed separately and mixed with a fixed amount of water. The mycoprotein-containing mixture is heated to 45° C. and the Trilesse/water mixture is added. The mixture is heated up to 55° C. before homogenisation using the Twin Panda Homogeniser is performed. A two-step homogenisation is performed (30 bar/150 bar) to obtain a milky like solution A Twin Panda Homogenizer is used to create a homogenous milky solution containing mycoprotein having hyphal lengths of about 20 μm.

In some cases, the Trilesse/water mixture may be added after the homogenisation step.

After homogenisation, the milky solution is heated to 90° C. and pasteurized for 15 minutes at 90° C. After cooling down to approximately 40° C., the milky solution is transferred to milk churns which contain approximately 2500 ml of the milk which is then mixed with the starter culture. In general, the starter culture is added with a dosage of 500 Units/2500 litres.

The inoculated foodstuff is incubated at 37° C. overnight and/or for at least 4 to 5 hours. Subsequently, the fermented mass is cooled to 25-30° C. in a cold chamber. After reaching that temperature, the fermented mass is gently stirred for 2 minutes in an Elbanton Yoghurtbath with suitable stirrers to obtain a smooth mass. After this treatment, the foodstuff is decanted into small pots and cooled to 4 to 7° C. for storage. At this stage, the pH of the foodstuff is below pH 4.50.

All equipment after pasteurisation is disinfected prior to any subsequent use.

### Examples 2 to 5—Preparation of Different Styles of Yoghurt-Like Foodstuffs

Following the general procedure detailed in Example 1, yoghurt-like foodstuffs were made having the compositions detailed in the table below:

Example No.

| Ingredient | 2 | 3 | 4 | 5 |
|---|---|---|---|---|
| Coconut milk | 12 | 12 | 6 | 12 |
| Oat milk | 0 | 0 | 6 | 0 |
| Sucrose | 4 | 4 | 4 | 4 |
| Glucose | 1 | 1 | 1 | 1 |
| Mycoprotein | 25 | 30 | 25 | 25 |
| paste | | | | |
| Stabiliser | 1.5 | 2 | 1.5 | 0.5 |
| Starter culture | 0.1 | 0.1 | 0.1 | 0.1 |
| Water | 56.4 | 50.9. | 56.4 | 57.4 |
| Total | 100 | 100 | 100 | 100 |

For the Example 3 foodstuff, the Trilesse was added after the homogenisation step.

The Example 5 foodstuff is prepared by using an additional homogenisation step after fermentation. The foodstuff is homogenised in a two-step homogenisation of 30 bar and 170 bar to obtain a liquid instead of a spoonable product. After homogenisation, the yoghurt-like drink is pasteurized for 1 minute at 72° C.

The foodstuffs of Examples 2 to 5 were assessed, and details are provided in the table below.

| Example | |
|---|---|
| No. | Discussion |
| 2 | This was a spoonable yoghurt-like foodstuff. It had a firm |
| | texture, no typical plant based off notes, neutral taste, acid to |
| | fresh acid. Viscosity assessed as per Test 1 was 7460 mPa |
| | and syneresis assessed as described in Test 2 was 0%. |
| 3 | This was a Greek-style yoghurt-like foodstuff. It had a very |
| | firm texture and was fresh in taste. Viscosity estimated based |
| | on Test 1 was 12000 mPa and syneresis assessed as |
| | described in Test 2 was 0%. |
| 4 | This was a hybrid yoghurt-like foodstuff. It had a slight oaty, |
| | grainy taste; and was thinner than Examples 2 and 3 |
| | foodstuffs. Viscosity assessed as per Test 1 was 4920 mPa |
| | and syneresis assessed as described in Test 2 was 1.5%. |
| 5 | This was a porridge-like, drinking yoghurt-like foodstuff. |
| | Viscosity assessed as per Test 1 was 3750 mPa and syneresis |
| | assessed as described in Test 2 was 0%. |

The foodstuffs of Examples 2 to 5 were blind tasted by suitably qualified and trained potential consumers and compared to existing commercially available comparable vegan yogurt-like foodstuffs. In each case, Examples 2 to 5 foodstuffs were regarded as improved compared to existing comparable foodstuffs, particularly in terms of taste (especially absence of off-notes often characteristic of vegan foodstuffs) and texture.

The foodstuffs of Examples 2 to 5 are found to be comparable to a plain or natural yoghurt—that is, a yoghurt with no additional flavourings such as fruit preparations or the like. Furthermore, the foodstuffs are high in protein and utilise a protein source (the mycoprotein) which has a high Protein Digestibility Corrected Amino Acid Score (PDCAAS), approaching a score of 1. In addition, the foodstuffs have acceptable colour, rheology and/or mouthfeel which mimics that of dairy yoghurt.

The excellent taste (and absence of off-notes) described above is a surprisingly advantageous effect associated with the foodstuffs of Examples 2 to 5. It is believed to result from the combination of the plant-based milks and the mycoprotein. Whilst not wishing to be bound by theory, it is believed to be based on the following: The bacteria of the starter culture tend to preferentially interact with (and catalyse the breakdown of) the most accessible nutrient sources whether they be components of the plant-based milk or components of the mycoprotein itself. Nutrient sources in plant-based milk tend to be less accessible than, for example, nutrient sources in animal milk. Consequently, when a combination of plant-based milk and mycoprotein is treated with the starter culture, the bacteria of the culture not only interact with the plant-based milk but also interact with components of the mycoprotein, some of which at least are believed to be responsible for off-notes that may otherwise be associated with the mycoprotein. Thus, off-notes may effectively be broken down by the bacteria of the starter culture, thereby reducing the overall level of off-notes in the foodstuff of examples 2 to 5. In contrast, if the plant-based milk was replaced with animal milk which has higher levels of nutrients which are readily available for interaction with the bacteria of the starter culture, the bacteria preferentially (if not exclusively) interact with (and catalyse the breakdown of) component of the animal milk, rather than the mycoprotein. This would mean that there would be negligible breakdown of potential off-note producing components of the mycoprotein.

Example 6 illustrates how mycoprotein paste can be fermented, in the absence of plant-based milks, and which may result in breakdown of potential off-note producing components in the mycoprotein.

### Example 6—Fermentation of Mycoprotein in the Absence of Plant-Based Milk

Following the general procedure detailed in Example 1, a foodstuff was made having the composition detailed in the table below:

| Ingredient | Weight (g) |
|---|---|
| Coconut milk 19% fat | 0 |
| Oat milk 2.8% fat | 0 |
| Sucrose | 210 |
| Glucose | 30 |
| Mycoprotein paste | 900 |
| (13.5% protein) | |
| Stabiliser | 60 |
| Starter culture | 3 |
| Water | 1797 |
| Total | 3000 |

It was found that the pH before fermentation was 5.96; and the pH after fermentation was 4.87. This confirms the mycoprotein itself is being fermented and acidic products produced which lends support to the theory expressed above for the apparent absence of off-notes in the foodstuffs of Examples 2 to 5.

In some cases, it may be desirable to improve the whiteness of the yoghurt-like foodstuffs described. This may be achieved by using a whiter paste which may be as described hereinafter.

The following assessments are referred to herein.

### Assessment 1—Colour Measurement

Paste cakes were measured for colour on a Minolta™ Chroma Meter using SpectraMagic™ software. In the assessment, a thin homogenous layer of paste was measured using a MinoltaChroma lens which had been suitably blanked against a white background (CR-210/CR-310/CR410 plate). The layer thickness may be at least 5 mm in the region measured so that light is reflected and not transmitted through the paste. Colour readings were given in the L*a*b* format.

### Assessment 2—Total Solids Measurement

These were either measured on a sartorius moisture analyser, or a paste of know weight was dried at 50° C. for 48 hours and reweighed and the solids content determined therefrom.

### Assessment 3-pH Assessment

In a fermenter, pH may be continuously assessed using an Applikon Applisens in line pH probe calibrated against pH 4 and 7 with temperature compensation built in via a fermenter temperature probe.

Outside a fermenter, on a liquid, pH may be assessed using a Mettler Toledo Fiveeasy pH meter with a LE409 probe. Temperature compensation is built in via an in-line probe, calibrated against pH 4 and 7.

A needle-type pH electrode can be used to pierce and penetrate solid samples.

### Example 7—General Procedure for Producing Whiter Mycoprotein Paste

A 15 L Applikon™ glass vessel, having a stirrer and inlet tube, was used to carry out fermentations.

Fusarium venenatum strain in glycerol was stored as 4 ml aliquots at −80° C. in cryovials prior to use.

The inoculum used in the fermentations was a sterile 200 ml volume of the medium described in Table A, having a pH of 6 which had been incubated (28° C., 110 rpm) for 48 hours. The medium was then inoculated with 4 ml of the frozen, mycelium glycerol stock of F. venenatum.

TABLE A
Fermentation medium, used in baffled flasks at pH 6

| Medium component | g/L |
|---|---|
| Potassium dihydrogen phosphate | 20 |
| Ammonium chloride | 4.4 |
| Potassium sulphate | 0.3 |
| Magnesium sulphate heptahydrate | 0.25 |
| TE solution - liquid solution comprising: | 5 ml |
| Iron II sulphate 7 hydrate 2.8 g/L | |
| Zinc chloride 1 g/L | |
| Manganese II chloride 4 hydrate 1 g/L | |
| Copper II chloride 0.2 g/L | |
| Cobalt II chloride 0.2 g/L | |
| Na molybdate 0.2 g/L | |
| CaCl₂ hydrate 2 g/L | |
| Citric acid 1.5 g/L | |
| Biotin | 1 ml |
| 0.3 g/L water | |

Batch growth was achieved at 10 L working volume in the 15 L Applikon™ glass vessel and controlled via EzControl™ software and live data logged via Applikon Lucullus™ software. The batch growth medium comprised the components in Table B plus separate, sterile, additions of glucose sugar (33 g/L final concentration), phosphoric acid 85% vv (1.16 ml/L final concentration) and iron sulphate heptahydrate (0.05 g/L final concentration).

TABLE B
Fermentation medium

| Media component | g/L |
|---|---|
| Potassium sulphate | 2 |
| Magnesium sulphate heptahydrate | 0.9 |
| Ca acetate | 0.2 |
| PPG | 0.5 ml |
| TE solution | 0.5 ml |
| Manganese sulphate 40 g/L | |
| Zinc sulphate 50 g/L | |
| Copper sulphate 5 g/L | |
| Biotin 50 mg/L | |
| Conc sulfuric acid 5 ml/L | |

For growth, the medium was pH adjusted to pH 6, after all components were added, with 30% v/v ammonium hydroxide which also served as a nitrogen source. The vessel was equilibrated to 28° C., set at an agitation of 600 rpm (with two Rushton™ impellors at 10 cm distance) and 10 L/min air (1 vvm) and when equilibrated, the dissolved oxygen (DO) was set to 100% under these conditions.

Off gas analysis was calibrated against air for both carbon dioxide and oxygen content and measured continuously throughout. A setpoint of 30% DO was mandated as a minimum, against a cascade control of 600-1000 rpm and 10-20 L/min air.

The broth was whitened in situ as follows: Once the culture had reached mid exponential phase of growth (usually after 24-36 hours, at a DO of 30% or when a dry cell weight of 6-8 g/L had been achieved) the broth was processed to make it whiter. Processing involved, first, switching off the pH control (to prevent any further additions of ammonium hydroxide; pH measurement however was maintained) and then setting the culture temperature setpoint to 50° C. (a slow ramp to this temperature from 28° C. then proceeded).

Immediately on readjusting the heating setpoint from 28° C., phosphoric acid (or any acid under study), was added via a 3-way feed inlet, to the culture. Concentrated phosphoric acid was typically used (85%) and approximately 5 ml was added to bring the pH down to 4 (or any relevant pH).

The vessel was then left under these conditions until 50° C. was measured (via an in-line temperature probe) and then held at that temperature for a further 5 minutes. The total time from temperature setpoint adjustment to this 5-minute hold could be as long at 45 minutes. This step aims to reduce the level of RNA in the biomass. At temperatures above 45° C., the vessel contents could be seen to whiten significantly.

The now whitened cells were harvested directly from the vessel sampling point into a manual press. Biomass was separated from supernatant or centrate, via a 30 μM mesh nylon filtration bag and the manual press. The white paste cake was then stored at 4° C. prior to use.

Paste produced as described compared to a control (where no pH adjustment to 4 was made, but processing in all other respects was identical) resulted in a visibly whiter paste. In measuring colour as described in Assessment 1, the L* value shifted up (Lighter) and a and b* values shifted down (compared to the control) significantly.

Table C details the results.

TABLE C
Colour change values for MEB paste adjusted
to pH 4 with phosphoric acid

| Sample | L* | a* | b* |
|---|---|---|---|
| Control MEB | 68.6 | 6.91 | 15.4 |
| pH 4 Phosphoric acid MEB | 87.26 | 0.28 | 1.11 |

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A foodstuff comprising:
a filamentous fungus; and
a plant-based milk.

2. The foodstuff according to claim 1, wherein said milk includes 0.1 to 10.0 wt %, of carbohydrates; 0.1 to 10.0 wt % of protein; and 1.0 to 20.0 wt % fat.

3. (canceled)

4. (canceled)

5. The foodstuff according to claim 1, wherein said milk is coconut milk and/or oat milk.

6. The foodstuff according to claim 1, wherein said foodstuff includes 4 to 14 wt %, of said milk, and wherein the sum of the wt % of all plant-based milks in the foodstuff is in the range 4 to 14 wt %.

7. (canceled)

8. The foodstuff according to claim 1, wherein said filamentous fungus has a Protein Digestibility Corrected Amino Acid Score (PDCAAS) of at least 0.95, and/or wherein said filamentous fungus includes at least 35 wt % protein on a dry mass basis.

9. (canceled)

10. (canceled)

11. The foodstuff according to claim 1, wherein said filamentous fungus comprises cells of Fusarium venenatum.

12. (canceled)

13. The foodstuff according to claim 1, wherein said filamentous fungus is derived from a biomass comprising said filamentous fungus, wherein said biomass has an L* of at least 70.0.

14. (canceled)

15. (canceled)

16. The foodstuff according to claim 1, wherein said foodstuff includes 5.0 to 10.0 wt %, of said filamentous fungus on a dry mass basis.

17. The foodstuff according to claim 1, wherein, in said foodstuff, the sum of the wt % of said filamentous fungus on a dry mass basis and said milk is at least 15 wt %; and said sum is less than 30 wt %.

18. (canceled)

19. The foodstuff according to claim 1, wherein, in said foodstuff, the sum of the wt % of said filamentous fungus on a dry mass basis, said milk and water is at least 90 wt %.

20. The foodstuff according to any preceding claim, wherein said foodstuff includes:
5 to 10 wt %, of said filamentous fungus on a dry mass basis;
4 to 14 wt %, of said milk; and
70 to 80 wt %, of water.

21. The foodstuff according to claim 20, wherein said foodstuff includes one or more stabilisers, wherein the sum of the wt % of stabilisers in said foodstuff is at least 0.1 wt %; wherein said stabiliser(s) comprise(s) pectin an a starch.

22. (canceled)

23. The foodstuff according to claim 20, wherein said foodstuff includes a residue of a bacterial culture.

24. The foodstuff according to claim 20, wherein said foodstuff includes less than 0.5 wt % a fruit or fruit flavourant.

25. The foodstuff according to claim 1, wherein said foodstuff has a protein content of at least 10 g/100 g of protein.

26. The foodstuff according to claim 20, wherein said foodstuff includes 0 wt % of ingredients of animal origin.

27. A process of making a foodstuff of claim 1, the process comprising mixing a filamentous fungus and a plant-based milk, wherein a biomass is selected comprising said filamentous fungus which biomass has L* in the range 75.0 to 95.0; inoculating a mixture of the filamentous fungus and said milk with a bacterial culture arranged to catalyse a fermentation reaction; undertaking a fermentation process comprising said filamentous fungus and said milk, wherein fermentation is undertaken to produce a mixture having a pH of less than 4.50.

28. (canceled)

29. (canceled)

30. (canceled)

31. (canceled)

32. A foodstuff which is a vegan yoghurt, the foodstuff comprising:
a filamentous fungus; and
a plant-based milk;
wherein said foodstuff includes at least 5.0 wt % of said filamentous fungus on a dry mass basis;
wherein said filamentous fungus comprises fungal mycelia and at least 80 wt % of said filamentous fungus comprise said fungal mycelia.

33. The foodstuff according to claim 32, wherein:
said milk includes 0.1 to 10.0 wt % of carbohydrates; or
said milk includes:
0.1 to 10.0 wt % of protein; and
1.0 to 20.0 wt % fat.

34. The foodstuff according to claim 32, wherein:
said milk is coconut milk and/or oat milk;
said foodstuff includes 4 to 14 wt % of said milk; and wherein the sum of the wt % of all plant-based milks in the foodstuff is in the range 4 to 14 wt %;
said filamentous fungus comprises cells of Fusarium venenatum;
said foodstuff includes 5.0 to 10.0 wt % of said filamentous fungus on a dry mass basis;
the sum of the wt % of said filamentous fungus on a dry mass basis, said milk and water is at least 90 wt %;
said foodstuff includes 5 to 10 wt % of said filamentous fungus on a dry mass basis, 4 to 14 wt % of said milk and 70 to 80 wt % of water;
said foodstuff includes a residue of a bacterial culture;
said foodstuff has a protein content of at least 10 g/100 g of protein;
said foodstuff includes 0 wt % of ingredients of animal origin.
